(19) United States
(12) Patent Application Publication
(10) Pub. No.: US 2008/0004195 A1
(43) Pub. Date: Jan. 3, 2008

(54) Composite member having gradually soluble coating film, and coating formation material

(75) Inventors: Hiroyuki Fujii, Fukuoka (JP); Satoru Kitazaki, Fukuoka (JP); Chikara Endo, Fukuoka (JP); Mitsuyoshi Kanno, Fukuoka (JP)

Correspondence Address: Carrier, Blackman & Associates, P.C., #100, 24101 Novi Road, Novi, MI, 48375, US

(73) Assignee: Toto Ltd., Kita-kyusyu-shi (JP)

(21) Appl. No.: 11/732,716

(22) Filed: Apr. 4, 2007

(30) Foreign Application Priority Data
Apr. 4, 2006 (JP) 2006-103661
Jul. 24, 2006 (JP) 2006-201162

(51) Int. Cl. C11D 3/37

(52) U.S. Cl. 510/193

(57) ABSTRACT

The present invention provides a gradually soluble coating film to be applied to instruments for waterworks.

In a conventional polyvinyl alcohol solution not containing metal salt, there is formed a coating film in which polyvinyl alcohol molecules are piled up as shown in FIG. 2(a). In such coating film, water contacting with a surface thereof penetrates rapidly to the interface between the coating film and a base material, so that when water flows away, the coating film flows out and vanishes completely. On the other hand, in a coating film of the present invention, there are formed polyvinyl alcohol inclusion metal hydroxide clusters derived from the kind of metal in the solution as shown in FIG. 2(b). Although polyvinyl alcohol is dissolved or swollen to allow water to penetrate therein when water contacts with the coating film surface, the penetration speed of water in the direction of film thickness is controlled since the metal hydroxide clusters exist in the film. Therefore, when water flows away, only the film in a water penetrated portion in the vicinity of the coating film surface flows and the entire coating film does not vanish at one time.

### BACKGROUND OF THE INVENTION

1. Field of the Invention

The present invention relates to a gradually soluble coating film and a coating composition for washing out dirt adhered to a surface by gradually dissolving in contact with water so as to durably develop the antifouling property.

2. Description of the Related Art

Generally, there is water scale adhesion in water temporarily flowing environments such as the inside of a toilet-bowl and the inside of a wash basin in a flush toilet, a floor and wall in a bathroom and the inside of a sink in a kitchen. Also, there is typical dirt in each environment such as adhesion of feces, darkening and yellowing in the toilet, sebaceous stains and soap dregs in the bathroom, darkening and oil stains in the kitchen, etc. As methods of preventing or cleaning adhesion of uncomfortable dirt, the followings are known.

Patent reference 1 discloses first and second inventions. In the first invention, there are disclosed a solution composition and a cleaning method wherein a water-soluble polymer and an active ingredient are applied to the toilet-bowl to form a coating film, and the active ingredient retained in the coating film is eluted out by dissolution of the polymer so as to develop cleaning performance. As the active ingredient developing the cleaning performance, a surface active agent is used.

Also, in the second invention, there are disclosed a solution composition and a cleaning method wherein the solution composition of the first invention and a solution containing borax are applied each to a toilet-bowl and reacted each other to form a coating film, and the active ingredient retained in the coating film is eluted out with dissolution of the coating film so as to develop cleaning performance.

In Patent reference 2, a polymer formed on a surface of a floor, a tile, a wall, a sink, etc. for making the surface hydrophilic is proposed. Specifically, there is disclosed such a copolymer of vinylpyrrolidone as N-vinylimidazole-N-vinylpyrrolidone (PVPVI) polymer and the like. Further, by adding multi-charged metal ion to this polymer, the polymer and the multi-charged metal ion act each other to produce a crosslink of polymer so that uniform polymer matrix is formed to decrease a coefficient of viscosity of the composition.

Patent reference 1: Japanese patent application publication No. 2005-187511

Patent reference 2: Japanese patent application national publication No. 2003-524681

As disclosed in Patent reference 1, there are so far well known a solution composition and a cleaning method using the solution composition to clean the dirt adhering to the coating film in which the active ingredient i.e. the surface active agent developing the cleaning performance from the inside of the coating film is eluted out whenever contacted with water. However, in the cleaning method using the solution composition as disclosed in the first invention of Patent reference 1, since water resisting property of the polymer component is low, the coating film is rapidly dissolved and fades out in a region where water flows at high velocity with high frequency such as the inside of the toilet-bowl, and in a region where hot water heated to 40 degrees centigrade or more contacts such as the bathroom. Accordingly, it is difficult to lastingly keep the cleaning effect.

Further, in the cleaning method using two kinds of the solution compositions as disclosed in the second invention of Patent reference 1, the polymer is cross-linked with borax to form a slimy coating film whose percentage of water content is large. Although the water resisting property of the coating film is improved by using together with borax, the film is exfoliated due to its low mechanical strength from the interface to a base material when used in the environment that water flows at high velocity such as the inside of the toilet-bowl. There is another problem that lasting cleaning performance is not obtained although the water resisting property is improved.

Both of the inventions disclosed in Patent reference 1 cause some trouble to consumers, and for the environment there is possibility of causing water pollution since the surface active agent as the active ingredient is frequently flown out in high density.

Further, although the composition in Patent reference 2 makes the surface property thereof hydrophilic by a specific polymer so as to improve the cleaning effect, the effect preventing the adhesion of the dirt by allowing itself to dissolve is poor.

### SUMMARY OF THE INVENTION

Therefore, the present invention aims to provide a solution (coating composition) applied to a hard surface for forming a gradually soluble coating film which has durability against water flow, and the gradually soluble coating film.

The coating composition according to the present invention contains at least a kind of water soluble polymer selected from the group of polyvinyl alcohol, polyacrylamide and hydroxyethyl cellulose, and metal salt forming a poorly-soluble hydroxide, in water.

It is preferable that the poorly-soluble metal hydroxide has a solubility product of less than 1×10⁻¹⁶. As a metal ion for forming the metallic hydroxide there are given Al(III), Fe(III), Cu(II), Cr(III) and the like.

The coating composition according to the present invention has a pH not greater than 7 when measured at a solution temperature of 20 degrees centigrade.

Further, the gradually soluble coating film is formed at normal temperature in a region where it temporarily contacts with water on a hard surface and contains at least a kind of water soluble polymer selected from the group of polyvinyl alcohol, polyacrylamide and hydroxyethyl cellulose, and metal salt forming a poorly-soluble hydroxide.

As a water resisting property of the gradually soluble coating film, it is preferable that coating thickness retention after dipping in ion exchange water at a water temperature of 20 degrees centigrade for 10 minutes is not less than 20% and not more than 85%.

Further, the gradually soluble coating film is formed at normal temperature. The film formation at normal temperature is carried out by applying a solution at normal temperature and drying the same.

According to the present invention it is possible to provide the gradually soluble coating film provided with durability against water flow, so that the region temporarily contacting with water on the hard surface can have lastingly such properties as an antifouling property and the like.

### BRIEF DESCRIPTION OF THE DRAWINGS

FIG. 1a is a schematic diagram showing a film thickness evaluation method of a formed coating film;

FIG. 1b is a schematic diagram showing a dissolution treatment method for a specimen on a surface of which a coating film is formed;

FIG. 2a is a schematic diagram showing a coating film which is formed only of polyvinyl alcohol, and the dissolution thereof; and

FIG. 2b is a schematic diagram showing a coating film formed by application of solution containing polyvinyl alcohol and metal salt which is capable of forming a poorly-soluble hydroxide, and the dissolution thereof.

### DETAILED DESCRIPTION OF THE PREFERRED EMBODIMENTS

For the purpose of easy understanding of the present invention, definitions and explanations with respect to expressions used in the present invention will be given hereunder.

(A Region Temporarily Contacting with Water of a Base Material having a Hard Surface)

The expression “base material having hard surface” denotes a coated or painted surface of an automobile, a bicycle or a motorcycle, a metallic surface such as a tire wheel, a surface of a window pane, a surface of a tiled building material and a coated or painted surface thereof in the outdoors, a surface of a water using device in the indoors or the like. Preferably, it denotes the water using device in the indoors, the coated or painted surface of an automobile body and the region temporarily contacting with water of the window pane. The expression “region temporarily contacting with water of water using device” denotes such a portion of a space forming device such as a toilet, a bathroom, a kitchen, a wash room or the like that it is dry in the unused condition while water flows or it is possible to let water flow in the used condition. Specifically, it denotes a surface of a toilet bowl or the like on which water flows, a wall, floor or door in a washing place of the bathroom on which hot water flows, a sink surface in the kitchen on which water flows when cooking or dish washing, a bowl surface of the wash room on which water flows in the case of face washing or tooth brushing, or the like. The region temporarily contacting with water of the coated or painted surface of the automobile body denotes the coated or painted surface of the automobile body which is usually dry but contacts with water when raining or snowing. The region temporarily contacting with water of the window denotes a window glass surface in the indoors on which dew condensed water is produced due to difference in temperature between the indoors and the outdoors in winter and a window glass surface in the outdoors which is usually dry but contacts with water when raining or snowing.

(Gradually Soluble Coating Film)

The expression “gradually soluble” denotes such a property that an entire coating film is not dissolved but a portion in the vicinity of the surface is dissolved in the case where water splashes or water flows. Since the coating film has such gradually soluble property, the coating film surface is dissolved whenever it contacts with water so as to flow away together with the dirt adhered thereto, whereby the lasting antifouling property can be developed. Further, the expression “gradually soluble coating film” denotes a coating film containing an available water soluble polymer and metal salt forming a poorly-soluble hydroxide. For example, although it is possible to form a water resistant coating film merely by using polyvinyl alcohol of high hydrolysis degree, the entire coating film swells and softens in the water flowing environment to which physical force is applied, so that the coating film is fallen off the interface in the close vicinity of the base material to be washed away. On the other hand, in the coating film which is comprised of the available water soluble polymer and the metal salt forming the poorly-soluble hydroxide, the water soluble polymer is prevented from swelling to increase durability against water flow thereby to develop the gradually soluble property.

(Hydrophilicity—Lipophilicity Balance of Water Soluble Polymer by Organic Conception Diagram: IOB Value)

In the organic conception diagram, with respect to physico-chemical material properties of compound, the level of the material properties mainly by Van Der Waals force is called as “organic” while the level of the material properties mainly by electric affinities is called as “inorganic” and these are grasped by a combination of “organic” and “inorganic”. In particular, when thinking about the origins of various properties with respect to organic compounds having hydrocarbon as a skeleton thereof, the property and condition thereof are comprised of two factors of the “organic” property of hydrocarbon formed by chains of covalent bonds between carbon chains and the “inorganic” property influenced by the electric affinities (ion) existing in a substitutional radical (functional radical). The organic conception diagram is the one that the organic property and the inorganic property are represented by organic values (hereinafter, referred to as OV) and inorganic values (hereinafter, referred to as IV) calculated from characteristic values derived from molecular structure of compounds and are plotted on orthogonal coordinates. Given that the OV of one carbon in the compound is “20”, the OV of the compound is obtained by adding an OV of organic-inorganic radical to the number of carbon×20 when the molecular structure has the organic-inorganic radical. On the other hand, with respect to the IV of an inorganic radical, given that a hydroxyl radical is 100, the IV of various kinds of the functional radicals are obtained on the basis of the influence of the hydroxyl radical upon a boiling point of the compound. The IV of the compound is obtained by adding the IV of each functional radical. It is possible to understand by replacing the organic property with a hydrophobic property and by replacing the inorganic property with a hydrophilic property. The hydrophobic property—hydrophilic property balance derived from the molecular structure of the compound is relatively compared by an IOB value calculated by the formula: IOB value=IV/OV. As the polymer is high, the hydrophobic property is strengthened to be more water soluble. (References: “Prescribed designing based on organic conception diagram” by Nihon Emulsion Co., Ltd., “Systematic organic qualification analysis (compounds)” published by Kazama Shobo Co., Ltd., “Organic conception diagram—foundation and application” published by Sankyo Shuppan Co., Ltd.)

(Available Water Soluble Polymer)

In the present invention, as the available water soluble polymer, such a water soluble polymer that the IOB value representing the hydrophobic property—hydrophilic property balance of the molecular structure is larger than 1.5 and smaller than 3.5 is preferred. More preferably, the IOB value is to be larger than 1.7 and smaller than 2.6. To put it concretely, polyvinyl alcohol (a product with the hydrolysis degree of 75 mol %: IOB value=1.800, a product with the hydrolysis degree of 85 mol %: IOB value=2.043, a product with the hydrolysis degree of 95 mol %: IOB value=2.333 and a product with the hydrolysis degree of 99.3 mol %: IOB value=2.476), hydroxyethyl cellulose (IOB value=2.500) and polyacrylamide (IOB value=2.250) are available.

(Polyvinyl Alcohol)

As available polyvinyl alcohol, it is preferable that the polymerization degree described in the catalog is not less than 500 and not more than 5000, the hydrolysis degree is not less than 75 mol % and the denaturation degree is not more than 10 mol %. When the polymerization degree is less than 500, the strength of the coating film is not obtained. When the polymerization degree is more than 5000, the coating film has a high coefficient of viscosity so as to be difficult to ensure the workability. In view of the solubility in a solvent having water as a main component and the durability of solution, it is preferable that the hydrolysis degree is not less than 75 mol %. It is possible to use the one that the organic radical is introduced into a principal chain for improving the water resistant property of polyvinyl alcohol. Then, in view of the solubility of the solvent having water as a main component, it is preferable that the denaturation degree is 10 mol % or less.

(Hydroxyethyl Cellulose)

Hydroxyethyl cellulose whose molecular amount is not less than 250000 is available. Preferably, the molecular amount is to be not less than 500000. More preferably, it is to be not less than 1000000.

(Polyacrylamide)

Polyacrylamide of an optional polymerization degree can be used. The one used as a polymer flocculant is preferable.

(Metal Salt Forming Poorly-Soluble Hydroxide)

The metal salt forming a poorly-soluble hydroxide denotes such metal salt that a hydroxide is separated when making a pH of an aqueous solution larger. With respect to the poorly-soluble hydroxide, it is preferable that the solubility product is less than 1×10⁻¹⁶. When the aqueous solution of such metal salt is added to an aqueous solution in which a water soluble polymer is dissolved, hydroxide clusters are formed and dispersed so as to be suspended in the solution. As available metal salt, there is given the one containing Al(III) ion, Cr(III) ion, Fe(III) ion and Cu(II) ion as a metal ion. On the other hand, non-preferable metal salt is the one containing Mg(II) ion, Zn(II) ion, Co(II) ion, Ni(II) ion, Ag(I) ion and the like as a metal ion. As a counterion, a chloride ion, a sulfuric acid ion, a nitric acid ion, a formic acid ion, an acetic acid ion and the like are preferable. Such a counterion that the gradually soluble property of the film is not obtained is not preferable. For example, in copper salt, salt containing a gluconic acid ion, an ethylene diamine tetraacetic acid ion and porphyrin is not preferable. (Solubility product: References “Chemistry handbook—revised 4th edition—foundation” edited by The Chemical Society of Japan and published by Maruzen Co., Ltd.)

(Quantity of Metal Salt)

It is preferable to set the quantity of the metal salt in the coating film to be a molar quantity of from 1/15 to 1/700 relative to a molar quantity of unit structure of the available water soluble polymer. When the molar quantity is more than 1/15, the coating film is getting insoluble while when it is less than 1/700, the durability against water flow can not be ensured. It is possible to control the gradually soluble property within the range from 1/15 to 1/700 in accordance with kinds of metal ions and counterions. Namely, it becomes possible to design the coating films which have different film thickness retention after contacting with water flow for a given period.

(Liquidity)

In view of the safety for a human body and surrounding devices in the case of practical use, it is preferable that a pH of the coating composition is 7 or less. More preferably, it is set to be greater than 4 and not greater than 7.

(Solvent, Dispersion Medium)

Although the solvent is formed mainly with water, it may contain alcohol such as ethanol, propanol or the like at a density of 25 wt % or less in order for ensuring the stability, workability and drying property. When containing over 25 wt %, the quality of the solution is deteriorated due to the decrease in stability, the generation of remarkable alcoholic smell and the like.

According to a preferred embodiment of the present invention, the coating composition of the present invention contains a water soluble polymer of from 0. 1% by weight to 10% by weight and preferably it contains from 0.1% by weight to 7% by weight. Also, according to a preferred embodiment of the present invention, it is preferable that the coating composition of the present invention contains metal salt of from 0.0005% by weight to 3.00% by weight. More preferably, it is contained from 0.001% by weight to 1.70% by weight. Further preferably, it is to be 0.001% by weight to 1.00% by weight.

(Coefficient of Viscosity)

It is preferable that the coefficient of viscosity of the solution at a temperature of 20 degrees centigrade measured by Brookfield type viscometer is not less than 2 mPa·s and not more than 200 mPa·s. In the case of the coefficient of viscosity of less than 2 mPa·s, the adhesion and persistence of the solution on various non-horizontal portions do not function so as not to obtain a predetermined film thickness. In the case of more than 200 mPa·s, defective coating occurs. Especially, when carrying out coating with a pump type hand spray, restrictions on the coefficient of viscosity are severe and the range from not less than 2 mPa·s to less than 50 mPa·s suitable. Spray pattern is not formed by the coefficient of viscosity of more than 50 mPa·s and the solution is spouted out in the form of a stick so as to incur the remarkable decrease in workability.

(Optional Component)

The following optional components are added for enhancing added value within the bounds capable of obtaining the gradually soluble property of the formed coating film without impairing the stability of the solution.

It is possible to add perfumes and aromatic water agents which are gradually released from the gradually soluble coating film and give out fragrance, antibacterial agents and anti-mold agents for preventing the reproduction of microbes, deodorant agents for deodorizing by reacting with odor components, and surface active agents which develops the cleaning property and the like. It is also possible to add a percolated absorption deodorant such as activated carbon, zeolite, apatite or the like which stays in the gradually soluble coating film so as to absorb and deodorize an offensive component, an inorganic filler such as a silica fine particle, an alumina fine particle or a zirconia fine particle which is capable of improving the mechanical strength of the coating film, an organic resin filler such as a polymethyl methacrylate fine particle, a silicone fine particle or a fluoro-polymer resin fine particle which is capable of improving the lubricity of the coating film surface, an anti-static agent such as tin oxide or a metal ultrafine particle which decreases the surface resistance of the coating film, an enzyme having the breakdown effect with respect to various dirt components such as protein, lipid, glucide or the like, a plasticizer such as glycerin or ethylene glycol which gives the flexibility to the coating film and the like. Further, it is possible to add a dispersing agent which exists in the solution to allow the optional components to disperse and stabilize, a thickener capable of improving the coating operation performance, an antifoaming agent capable of preventing bubbling at the time of the coating operation, a buffer agent for adjusting the pH of the solution, a preservative for preventing putrefaction and change in quality of the solution, pigment for coloring the solution and the like.

(Spray Agent)

The spray agent of the present invention comprises the coating composition filled in a container which is provided with a spray device. As the spray device, sprayers such as an aerosol type, a manual trigger, a manual pump or the like can be used. Among these, the manual trigger or the manual pump which is a manual spray device is preferable. Especially, the manual trigger is preferable. As the manual spray device, the one that the composition of from 0.1 g to 2.0 g, preferably from 0.2 g to 1.5 g, and more preferably from 0.3 g to 1.3 g is spouted out at one spray is preferable. Further, in the case where the composition at a temperature of 20 degrees centigrade is spayed in the position 20 cm remote from the base material, such container that an area when the composition adheres to the base material at one spray becomes from 10 cm² to 200 cm², preferably, 20 cm² to 120 cm² and more preferably, 30 cm² to 100 cm² is preferable. Moreover, it is preferable that the spray device available for the present invention is provided with a means for hermetically plugging an outlet port for spouting out the solution. Preferably, the hermetically plugging means comprises a lid for preventing the drying of the solution inside of the outlet port at the time of keeping. It is preferable that the lid is detachable or able to open and close.

(Coating Film Formation at Normal Temperature)

In the case where the solution (coating composition) is applied for the coating film formation, after cleaning a surface to be coated of the instrument for waterworks, it is possible to use a spray coat method, a flow coat method, a method of spreading coat over the surface with a wool roller or sponge, a method of coating the surface with an unwoven fabric cloth impregnated with the solution and the like. The coat formation can be made, whether the surface to be coated is in a dry condition or in a wet condition. The coat formation does not require a heating process step in particular. In the curing condition of drying at normal temperature for about 30 minutes, the coating film developing the gradually soluble property is formed and becomes usable.

(Film Thickness Measurement)

The film thickness of the formed coating film is evaluated in a cross section observation mode with a surface roughness meter “SURFCOM 130A” made by Tokyo Seimitsu Co., Ltd.

(Film Thickness)

The coating solution of the present invention can be recoated and the formed coating film is gradually dissolved from the surface in contact with water. Therefore, the film thickness can be chosen suitably in accordance with a predetermined effective duration. For example, in the case of fixing the effective duration of the antifouling effect for a week, the film thickness of not less than 100 nm and not more than 20 μm is preferable.

(Gloss Applying and Retaining Effects)

The surface of the coating film formed according to the present invention has a high gloss. Even if the high glossy surface whose gloss value in the first stage is 90 or higher is losing the gloss thereof to the level of about 50 due to aged deterioration, the coating film surface formed by application of the solution according the present invention recovers its gloss value to the same level as the one in the first stage. Further, since the coating film is gradually soluble, the high gloss surface is retained.

(Alternative Characteristic of Gradually Soluble Property)

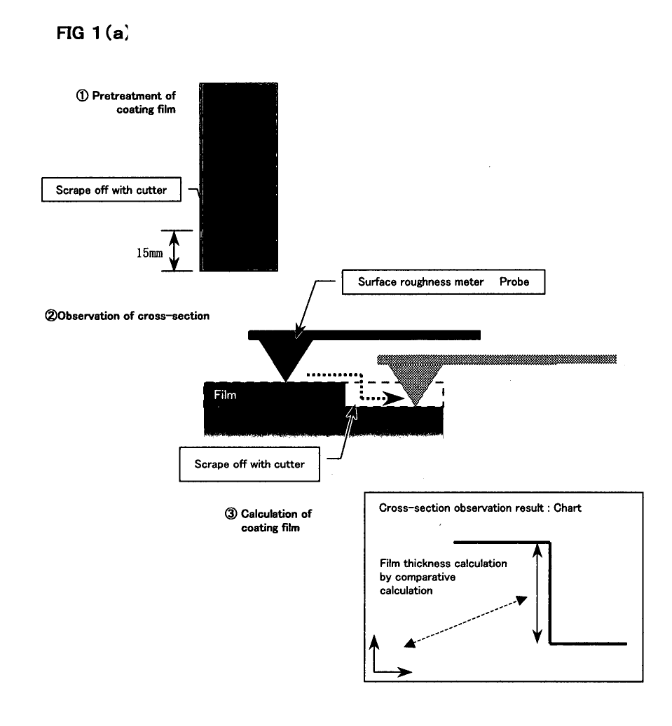

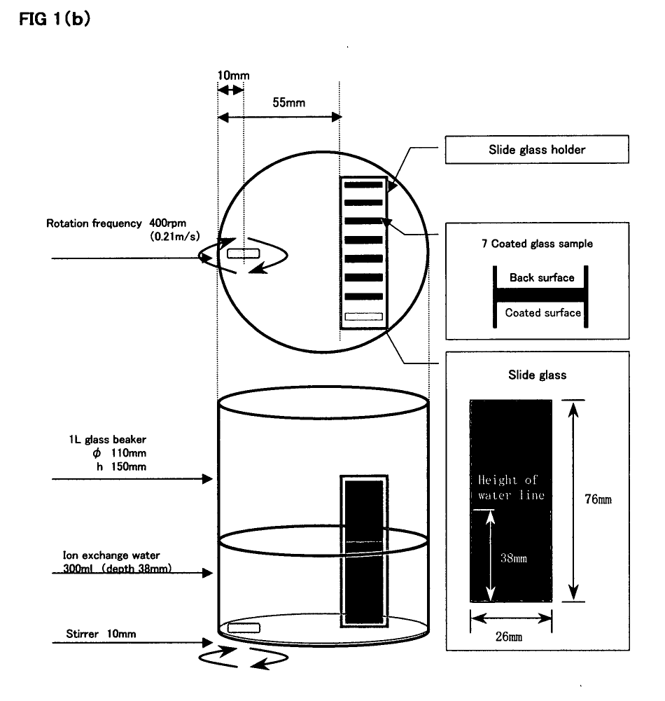

In the present invention, the film thickness retention is expressed as an alternative characteristic of the gradually soluble property. A specimen is obtained by flow coating the solution on an upright slide glass and drying it at a temperature of 25 degrees centigrade for 12 hours. As shown in FIG. 1(a), after exfoliating a portion of the formed coating film, the film thickness A is calculated by having a probe scanned continuously on the coating film surface and a base material surface of the slide glass to measure the cross sectional form. Next, after dipping the same specimen in ion exchange water at a temperature of 20 degrees centigrade for 10 minutes in such conditions as shown in FIG. 1b, the film thickness B is measured. The film thickness retention (%) is calculated by a ratio of the film thickness B to the film thickness A.

It is preferable that the film thickness retention is not less than 20% and less than 85%. When it is less than 20%, the coating film is excessively dissolved so as not to retain the antifouling property. On the other hand, when it is not less than 85%, it becomes difficult to wash away the adhered dirt by dissolution of a film surface layer. When the film thickness retention is designed to be the above mentioned range, it is possible to develop the lasting antifouling effect by the gradually soluble property.

(Mechanism of Action)

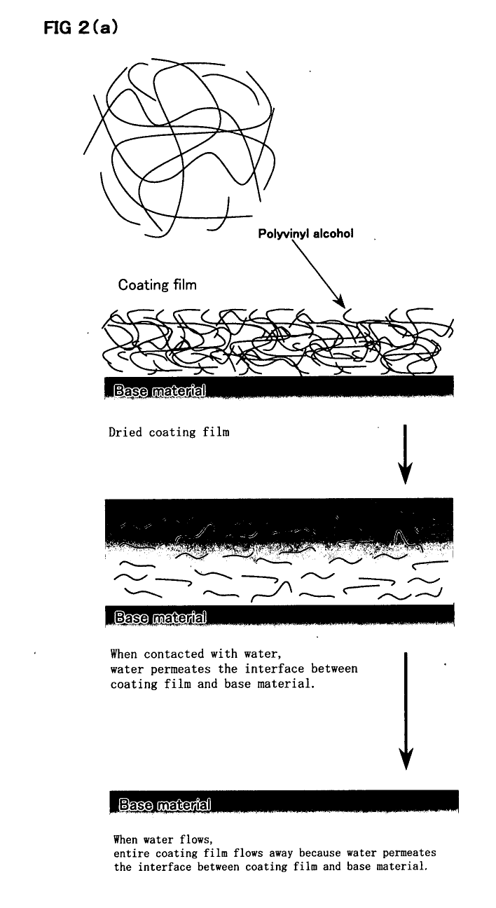

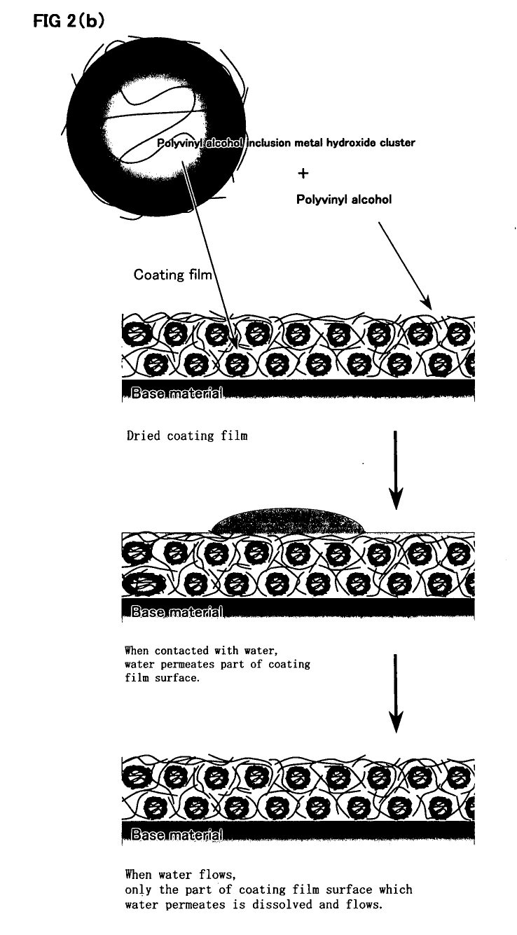

In the present invention, although the mechanism that the coating film develops the gradually soluble property is not surely confirmed, it is thought that it is caused by a peculiar structure of the coating film as explained hereunder. Herein, the following explanation is a hypothesis yet to be confirmed, and the present invention will not be limited thereto. Namely, in the polyvinyl alcohol solution not containing the metal salt of the present invention, there is formed a coating film in which polyvinyl alcohol molecules are piled up as shown in FIG. 2(a). In such coating film, water contacting with a surface of the film penetrates rapidly to the interface between the coating film and a base material, so that when water flows away, the coating film flows out and vanishes completely.

On the other hand, in the coating film obtained by drying the solution of the present invention at normal temperature, there are formed polyvinyl alcohol inclusion metal hydroxide clusters derived from the kind of metal in the solution as shown in FIG. 2(b). In this respect, it is thought that polyvinyl alcohol exists in such a state as binding the metal hydroxide clusters. When water contacts with the coating film surface, polyvinyl alcohol is dissolved or swollen to allow water to penetrate therein. However, it is considered that since the metal hydroxide clusters exist in the film, the penetration speed of water in the direction of film thickness is controlled. It is also considered that when water flows away, only the film in a water penetrated portion in the vicinity of the coating film surface flows together with water and therefore the entire coating film does not vanish at one time. Then, it is considered that this phenomenon is repeated every time the coating film contacts with water so that the coating film develops the gradually soluble property.

(Various Functions and Uses Obtained)

When the gradually soluble coating film of the present invention is employed, such functional properties as an aromatic property, an antibacterial property, a anti-mold property, an odor preventing property, a deodorant property, an antifouling property, a glossy property and the like can be developed.

The explanation will be made with respect to the uses as follows.

Antifouling Property:

For example, when the cleaning water flows, the surface layer of the coating film is dissolved and the dirt adhered thereto is exfoliated to renew the surface so that a clean surface is formed every time the toilet is cleaned. In view of the application of the same operation, the coating film is applicable to bowl surfaces of a urinal and stool, a bowl surface of a washbasin of a washing stand, a sink of a kitchen and each portion of a bathroom as indoor instruments for waterworks. Also, it is applicable to a coated surface of an automobile body and window glass surfaces facing indoors and outdoors. The prevention of the dirt such as feces, water scale, water mark, sebaceous dirt, soap lees, oil stain or the like is effectively performed.

Antibacterial Property, Anti-Mold Property/Odor Preventing Property:

Since the clean surface is formed every time water flows on the coating film, the adhesion of microbes is able to be prevented. Also, since the antibacterial agent and the anti-mold agent are released every time the coating film surface is dissolved by using copper salt having the antibacterial property or by adding the antibacterial agent and the anti-mold agent as the optional components, the reproduction of microbes such as bacteria and molds is able to be prevented. Further, the putrefaction smell caused by the reproduction of microbes is able to be prevented. Accordingly, this coating film is applicable to the bowl surfaces of the urinal and stool, the bowl surface of the washbasin of the washing stand, the sink of the kitchen and each portion of the bathroom.

Aromatic Property:

When perfumes are added as the optional component, the perfumes are gradually dissolved by the above gradually soluble effect thereby allowing fragrance to be released into the air. As the applicable uses, there are given the urinal and stool, peripheral portions of a drain port of the bathroom or the kitchen and the like.

Deodorant Property:

When the deodorant agent is added as the optional component, it is released every time water flows by the gradually soluble effect, so that the offensive odors can be deodorized every time water flows. As the applicable uses, there are given the urinal and stool, peripheral portions of the drain port of the bathroom or the kitchen and the like.

Glossing Property:

The coating film retains superior external appearance even if the coating composition is recoated repeatedly. Therefore, when coated on the surface losing the gloss in the first stage due to deterioration of the surface, the surface becomes smooth so as to enable the gloss to recover. The coating film does not flows away in an instant but is gradually dissolved from the surface layer in the case of contacting with water, the gloss can be retained for a duration in accordance with the formed film thickness and the water flow. As the uses of such coating film, there are given glazed surfaces of sanitary ceramic instruments causing the deterioration of gloss by long term use. Specifically, the coating film is applicable to the bowl surfaces of the urinal and stool, the bowl surface of the washbasin of the washing stand and the like. Further, it is also applicable to the painting or coating surface of the automobile body or the like causing striped cleaning marks by the long term use.

### EXAMPLES

Compositions of solutions with respect to examples of the present invention and comparative examples each are shown in Table 1 and Table 2. The solutions were formed by prescribing constituent materials in accordance with the composition described in Tables and kept standing still for a day so as to be used for various kinds of evaluation.

TABLE 1

| | | | | | Composition (wt %) | | | | | | | | | |
|---|---|---|---|---|---|---|---|---|---|---|---|---|---|---|
| | | | | | Exam- | Exam- | Exam- | Exam- | Exam- | Exam- | Exam- | Exam- | Exam- | Exam- |
| Material | | | | | ple 1 | ple 2 | ple 3 | ple 4 | ple 5 | ple 6 | ple 7 | ple 8 | ple 9 | ple 10 |
| | | | Saponi- | Dena- | | | | | | | | | | |
| | | Polymer- | fication | turation | | | | | | | | | | |
| | | ization | degree | degree | | | | | | | | | | |
| | | degree | (mol %) | (mol %) | | | | | | | | | | |
| Coating | polyvinyl | 3300 | 99.3 | 0 | 3 | 3 | 3 | | | | | | | |
| film | alcohol | 1000 | 99.3 | <0.7 | | | | 4 | | | | | | |
| formation | | 1000 | 98.5 | <1.5 | | | | | 4 | 4 | | | | |
| polymer | | 500 | 98.5 | <1.5 | | | | | | | 6.3 | | | |
| | | 1000 | 99.3 | 0 | | | | | | | | 4 | | |
| | | 1700 | 96.5 | 0 | | | | | | | | | 3.5 | |
| | | 1000 | 88 | 0 | | | | | | | | | | 4 |

Polyacrylamide Molecular amount
16 million
Hydroxyethyl cellulose Molecular
amount 1.02 million

| | | | | | | | | | | | |
|---|---|---|---|---|---|---|---|---|---|---|---|
| Metal | Copper (II) acetate | 0.191 | 0.046 | 0.023 | 0.092 | 0.138 | 0.041 | 0.108 | 0.103 | 0.578 | 0.826 |
| salt | Copper (II) formate | | | | | | | | | | |
| | Copper (II) sulfate | | | | | | | | | | |
| | Copper (II) chloride•2 hydrate | | | | | | | | | | |
| | Iron (III) chloride•9 hydrate | | | | | | | | | | |
| | Aluminum (III) | | | | | | | | | | |
| | nitrate•9 hydrate | | | | | | | | | | |
| Solvent | Ethanol | | | | | | 5 | | | | |
| | 2-propanol | | | | 5 | 20 | | 5 | | | 5 |
| Surfactant | Anionic | 0.025 | 0.025 | 0.025 | 0.035 | | | 0.035 | 0.025 | | |
| | Nonionic | | | | | | | | | | |

| | | | | | |
|---|---|---|---|---|---|
| Antifoamer | 0.01 | 0.01 | 0.02 | 0.015 | 0.02 |

| | | | | | Composition (wt %) | | | | | | | | |
|---|---|---|---|---|---|---|---|---|---|---|---|---|---|
| | | | | | Exam- | Exam- | Exam- | Exam- | Exam- | Exam- | Exam- | Exam- | Exam- |
| | | | | | ple | ple | ple | ple | ple | ple | ple | ple | ple |
| Material | | | | | 11 | 12 | 13 | 14 | 15 | 16 | 17 | 18 | 19 |
| | | | Saponi- | Dena- | | | | | | | | | |
| | | Polymer- | fication | turation | | | | | | | | | |
| | | ization | degree | degree | | | | | | | | | |
| | | degree | (mol %) | (mol %) | | | | | | | | | |
| Coating | polyvinyl | 3300 | 99.3 | 0 | 2.5 | 3 | 3 | 3 | 3 | 3 | | | |
| film | alcohol | 1000 | 99.3 | <0.7 | | | | | | | 4 | | |
| formation | | 1000 | 98.5 | <1.5 | | | | | | | | | |
| polymer | | 500 | 98.5 | <1.5 | | | | | | | | | |
| | | 1000 | 99.3 | 0 | | | | | | | | | |
| | | 1700 | 96.5 | 0 | 1 | | | | | | | | |
| | | 1000 | 88 | 0 | | | | | | | | | |

| | | |
|---|---|---|
| Polyacrylamide Molecular amount 16 million | 0.72 | |
| Hydroxyethyl cellulose Molecular amount 1.02 | | 1 |
| million | | |

| | | | | | | | | | | |
|---|---|---|---|---|---|---|---|---|---|---|
| Metal | Copper (II) acetate | 0.023 | | | | | | | 0.041 | 0.005 |
| salt | Copper (II) formate | | 0.114 | 0.057 | | | | | | |
| | Copper (II) sulfate | | | | 0.081 | | | | | |
| | Copper (II) chloride•2 hydrate | | | | | 0.043 | | | | |
| | Iron (III) chloride•9 hydrate | 0.137 | | | | | 0.068 | | | |
| | Aluminum (III) nitrate•9 hydrate | | | | | | | 0.550 | | |
| Solvent | Ethanol | | | | | | | 5 | | |
| | 2-propanol | | | | | | | | | |
| Surfactant | Anionic | 0.03 | 0.025 | 0.025 | 0.025 | 0.025 | 0.025 | 0.025 | | |
| | Nonionic | | | | | | | | | |

| | |
|---|---|
| Antifoamer | 0.01 |

With respect to Example 1 through Example 10, Example 12 through the Example 15, Example 18 and Example 19, pH of the solutions was from 4.5 to 7.0. The pH of the solutions of Example 11, Example 16 and Example 17 was from 2.0 to 4.5.

TABLE 2

| | | | | | Composition (wt %) | | | | |
|---|---|---|---|---|---|---|---|---|---|
| | | | | | Comparative | Comparative | Comparative | Comparative | Comparative |
| Material | | | | | example 1 | example 2 | example 3 | example 4 | example 5 |
| | | Polymer- | Saponification | Denaturation | | | | | |
| | | ization | degree | degree | | | | | |
| | | degree | (mol %) | (mol %) | | | | | |
| Coating | PVA | 3300 | 99.3 | 0 | | 3 | | | |
| film | | 1000 | 99.3 | <0.7 | | | | | 4 |
| formation | | 1000 | 98.5 | <1.5 | | | | | |
| polymer | | 1000 | 88 | 0 | 4 | | 4 | 4 | |
| | Polyvinyl pyrrolidone Molecular amount | | | | | | | | |
| | 1.2 million | | | | | | | | |
| | Xanthan gum | | | | | | | | |
| | Acrylic resin emulsion | | | | | | | | |
| | Silica sol | | | | | | | | |
| Metal salt | Copper (II) acetate | | | | | | | | 0.660 |
| | Copper (II) gluconate | | | | | | | | |
| | Copper (II) disodium | | | | | | | | |
| | ethylenediaminetetraacetate | | | | | | | | |
| | Copper (II) chlorophilline sodium | | | | | | | | |
| | Magnesium (II) nitirde•6 hydrate | | | | | | | | |
| | Nickel (II) nitride•4 hydrate | | | | | | | | |
| | Zinc (II) acetate•2 hydrate | | | | | | | | |
| | Cobalt (II) nitride•6 hydrate | | | | | | | | |
| | Silver (I) acetate | | | | | | | | |
| | Zirconium oxynitride•2 hydrate | | | | | | | | |
| | Borax | | | | | | | 4.000 | |
| Solvent | Ethanol | | | | | | | | |
| | 2-propanol | | | | | | | | |
| Surfactant | Anionic | | | | | | 4 | | |
| | Nonionic | | | | | 2 | | | |
| Antifoamer | | | | | | | | | |
| | | | | | Composition (wt %) | | | | |
| | | | | | Comparative | Comparative | Comparative | Comparative | Comparative |
| Material | | | | | example 6 | example 7 | example 8 | example 9 | example 10 |
| | | Polymer- | Saponification | Denaturation | | | | | |
| | | ization | degree | degree | | | | | |
| | | degree | (mol %) | (mol %) | | | | | |
| Coating | PVA | 3300 | 99.3 | 0 | | 3 | 3 | 3 | |
| film | | 1000 | 99.3 | <0.7 | | | | | 4 |
| formation | | 1000 | 98.5 | <1.5 | | | | | |
| polymer | | 1000 | 88 | 0 | 5.5 | | | | |
| | Polyvinyl pyrrolidone Molecular amount | | | | | | | | |
| | 1.2 million | | | | | | | | |
| | Xanthan gum | | | | | | | | |
| | Acrylic resin emulsion | | | | | | | | |
| | Silica sol | | | | | | | | |
| Metal salt | Copper (II) acetate | | | | 0.028 | | | | |
| | Copper (II) gluconate | | | | | 0.348 | | | |
| | Copper (II) disodium | | | | | | 0.641 | | |
| | ethylenediaminetetraacetate | | | | | | | | |
| | Copper (II) chlorophilline sodium | | | | | | | 0.165 | |
| | Magnesium (II) nitirde•6 hydrate | | | | | | | | 0.466 |
| | Nickel (II) nitride•4 hydrate | | | | | | | | |
| | Zinc (II) acetate•2 hydrate | | | | | | | | |
| | Cobalt (II) nitride•6 hydrate | | | | | | | | |
| | Silver (I) acetate | | | | | | | | |
| | Zirconium oxynitride•2 hydrate | | | | | | | | |
| | Borax | | | | | | | | |
| Solvent | Ethanol | | | | | | | | |
| | 2-propanol | | | | | | | | 5 |
| Surfactant | Anionic | | | | | | | | |
| | Nonionic | | | | | | | | |
| Antifoamer | | | | | | | | | |
| | | | | | Composition (wt %) | | | | |
| | | | | | Comparative | Comparative | Comparative | Comparative | Comparative |
| Material | | | | | example 11 | example 12 | example 13 | example 14 | example 15 |
| | | Polymer- | Saponification | Denaturation | | | | | |
| | | ization | degree | degree | | | | | |
| | | degree | (mol %) | (mol %) | | | | | |
| Coating | PVA | 3300 | 99.3 | 0 | | | | | |
| film | | 1000 | 99.3 | <0.7 | 4 | 4 | 4 | 4 | |
| formation | | 1000 | 98.5 | <1.5 | | | | | 4 |
| polymer | | 1000 | 88 | 0 | | | | | |

| | | | | | | |
|---|---|---|---|---|---|---|
| | Polyvinyl pyrrolidone Molecular amount | | | | | |
| | 1.2 million | | | | | |
| | Xanthan gum | | | | | |
| | Acrylic resin emulsion | | | | | |
| | Silica sol | | | | | |
| Metal salt | Copper (II) acetate | | | | | |
| | Copper (II) gluconate | | | | | |
| | Copper (II) disodium | | | | | |
| | ethylenediaminetetraacetate | | | | | |
| | Copper (II) chlorophilline sodium | | | | | |
| | Magnesium (II) nitirde•6 hydrate | | | | | |
| | Nickel (II) nitride•4 hydrate | 0.905 | | | | |
| | Zinc (II) acetate•2 hydrate | | 0.200 | | | |
| | Cobalt (II) nitride•6 hydrate | | | 0.196 | | |
| | Silver (I) acetate | | | | 0.303 | |
| | Zirconium oxynitride•2 hydrate | | | | | 0.110 |
| | Borax | | | | | |
| Solvent | Ethanol | | | 2 | | |
| | 2-propanol | | | | 5 | |
| Surfactant | Anionic | | | | | |
| | Nonionic | | | | | |

Antifoamer

| | Composition (wt %) | | | |
|---|---|---|---|---|
| | Comparative | Comparative | Comparative | Comparative |
| Material | example 16 | example 17 | example 18 | example 19 |

| | | | | |
|---|---|---|---|---|
| | | | Saponification | Denaturation |
| | | Polymerization | degree | degree |
| | | degree | (mol %) | (mol %) |
| Coating | PVA | 3300 | 99.3 | 0 |
| film | | 1000 | 99.3 | <0.7 |
| formation | | 1000 | 98.5 | <1.5 |
| polymer | | 1000 | 88 | 0 |

| | | | | | |
|---|---|---|---|---|---|
| | Polyvinyl pyrrolidone Molecular amount 1.2 million | 3.5 | | | |
| | Xanthan gum | | 0.1 | | |
| | Acrylic resin emulsion | | | 5 | |
| | Silica sol | | | | 2 |
| Metal salt | Copper (II) acetate | 0.081 | 0.020 | | |
| | Copper (II) gluconate | | | | |
| | Copper (II) disodium | | | | |
| | ethylenediaminetetraacetate | | | | |
| | Copper (II) chlorophilline sodium | | | | |
| | Magnesium (II) nitirde•6 hydrate | | | | |
| | Nickel (II) nitride•4 hydrate | | | | |
| | Zinc (II) acetate•2 hydrate | | | | |
| | Cobalt (II) nitride•6 hydrate | | | | |
| | Silver (I) acetate | | | | |
| | Zirconium oxynitride•2 hydrate | | | | |
| | Borax | | | | |
| Solvent | Ethanol | | | | |
| | 2-propanol | | | | |
| Surfactant | Anionic | | | | |
| | Nonionic | | | | |

Antifoamer

Evaluation 1: Evaluation of Gradually Soluble Property

The gradually soluble property of coating films formed by drying at the temperature for 12 hours the solutions of the examples in Table 1 and the comparative examples in Table 2 was evaluated in accordance with the procedures referred to in the sections “(Film thickness)” and “(Mechanism of action)”. The judgment was carried out by the film thickness retention in such a condition that the film thickness retention of not less than 20% and not more than 85% is “OK” and the retention of less than 20% and more then 85% is “NG”. The results of judgment with respect to Evaluation 1 are shown in Table 3.

TABLE 3

| Solution | Judgment |
|---|---|
| Example 1 | OK |
| Example 2 | OK |
| Example 3 | OK |
| Example 4 | OK |
| Example 5 | OK |
| Example 6 | OK |
| Example 7 | OK |
| Example 8 | OK |
| Example 9 | OK |
| Example 10 | OK |
| Example 11 | OK |
| Example 12 | OK |
| Example 13 | OK |
| Example 14 | OK |
| Example 15 | OK |
| Example 16 | OK |
| Example 17 | OK |
| Example 18 | OK |
| Example 19 | OK |
| Comparative Example 1 | NG |
| Comparative Example 2 | NG |
| Comparative Example 3 | NG |
| Comparative Example 4 | NG |
| Comparative Example 5 | NG |
| Comparative Example 6 | NG |
| Comparative Example 7 | NG |
| Comparative Example 8 | NG |
| Comparative Example 9 | NG |
| Comparative Example 10 | NG |
| Comparative Example 11 | NG |
| Comparative Example 12 | NG |
| Comparative Example 13 | NG |
| Comparative Example 14 | NG |
| Comparative Example 15 | NG |
| Comparative Example 16 | NG |
| Comparative Example 17 | NG |
| Comparative Example 18 | NG |
| Comparative Example 19 | NG |

As shown in Table 3, the film thickness retention of the coating films formed by the solutions of the examples were all within the range of not less than 20% and not more than 85%, and the gradually soluble property that the solubility is properly controlled was developed.

On the other hand, with respect to the coating films formed by the solutions of Comparative example 1 through Comparative example 4 and Comparative example 6 through Comparative example 17, it was not possible to detect the coating films after dissolution test. Also, the film thickness retention of the coating films formed by the solutions of Comparative example 5 and Comparative example 18 was greater than 85%, and the coating films were the ones having a high water resisting property.

Evaluation 2: Stability of Solution

In such a condition as letting the solutions of the examples in Table 1 and Comparative example 4, Comparative example 14, Comparative example 15 and Comparative example 17 in Table 2 stand in a room of normal temperature, changes of external appearance and state of the solutions were evaluated by a visual inspection. The one that no change occurs was judged as “OK” and the one that change occurs was done as “NG”.

The results of judgment with respect to Evaluation 2 are shown in Table 4.

TABLE 4

| | External appearance | |
|---|---|---|
| Solution | and State | Judgment |
| Example 1 | No change | OK |
| Example 2 | No change | OK |
| Example 3 | No change | OK |
| Example 4 | No change | OK |
| Example 5 | No change | OK |
| Example 6 | No change | OK |
| Example 7 | No change | OK |
| Example 8 | No change | OK |
| Example 9 | No change | OK |
| Example 10 | No change | OK |
| Example 11 | No change | OK |
| Example 12 | No change | OK |
| Example 13 | No change | OK |
| Example 14 | No change | OK |
| Example 15 | No change | OK |
| Example 16 | No change | OK |
| Example 17 | No change | OK |
| Example 18 | No change | OK |
| Example 19 | No change | OK |
| Comparative | Gelled | NG |
| Example 4 | | |
| Comparative | Turned red-brown | NG |
| Example 14 | | |
| Comparative | Increase in viscosity | NG |
| Example 15 | | |
| Comparative | Blue cohesive | NG |
| Example 17 | product | |

The changes of external appearance and the state were not recognized in the solutions of the examples and it was confirmed that the solutions have the excellent storage stability. On the other hand, the solution of the comparative example gelled, the solution of the comparative example turned red-brown, the solution of Comparative example 15 remarkably increased in the coefficient of viscosity and the solution of Comparative example 17 caused a blue cohesive product.

Evaluation 3: Feces Adhesion Preventing Effect

The feces frequently adhere to a ceramic surface above a stagnant water surface in a Western style toilet and a part of the feces still remains even if the cleaning water is flushed. On a family that brushes and washes a toilet bowl with frequency of once every three days or more for the reason mentioned above, a monitor test was conducted for grasping the effect of various kinds of the solutions on the remaining feces after flushing. The subject family is 4 people and the installed toilet bowl is a washing-off type toilet bowl which has a narrow stagnant water surface. The solutions of Example 2 and Example 7 in Table 1 and Comparative example 3, Comparative example 7 and Comparative example 18 in Table 2 were sampled for the test. The number of people for the monitor is three families each for each of the solutions. The solutions were spray-coated all over on the ceramic surface inside the previously brush-washed toilet bowl and dried for 60 minutes to start using the toilet. The number of days from the start of use to the cleaning due to the adhesion of feces was evaluated. The case of cleaning after 4 days or more elapsed was judged as “OK”, while the case of doing after 3 days or less elapsed was judged as “NG”.

The results of Evaluation 3 are shown in Table 5.

TABLE 5

| Solution | Monitor | Judgment |
|---|---|---|
| Example 2 | A | OK |
| | B | OK |
| | C | OK |
| Example 7 | D | OK |
| | E | OK |
| | F | OK |
| Comparative | G | NG |
| example 3 | H | NG |
| | I | NG |
| Comparative | J | NG |
| example 7 | K | NG |
| | L | NG |
| Comparative | M | NG |
| example 18 | N | NG |
| | O | NG |
| Uncoated | P | NG |
| | Q | NG |
| | R | NG |

As shown in Table 5, with respect to the families using the solutions of Examples 2 and Example 7, more than 4 days elapsed from the start of the monitor to the brush-cleaning, and the coating of the solutions developed the lasting antifouling property. On the other hand, with respect to the families using the solutions of Comparative example 3 and Comparative example 7 which are remarkably dissolved, the frequency of cleaning was not lessened even in the case of using the solution, and the antifouling effect was not obtained. Similarly, with respect to the family using the solution which forms the coating film of high water resisting property, the frequency of cleaning was not lessened and the antifouling effect was not obtained.

Evaluation 4: Black Mold Preventing Effect

Specimens were prepared by coating and spreading over with a sponge the solutions of Example 5 in Table 1 and Comparative example 7 in Table 2 on a glazed surface of a tile having a glassy glazed layer on the surface thereof and drying them at a temperature of 25 degrees centigrade for 12 hours. The anti-mold performance before and after carrying out the dissolution test referred to in the section of “(Film thickness)” was evaluated. In the test, there was sampled Cladosporium sp. isolated from a practically used bathroom. 500 μl of a nutritive liquid containing 0.8% of glucose and 0.2% of peptone and a spore 5×10³ of Cladosporium sp. were inoculated on the specimen and cultured at a temperature of 27 degrees centigrade and at 90% or more of humidity for a week. The one that the development of mycelia can not be confirmed by a visual inspection was evaluated as “anti-mold level 3”. The one that the development of mycelia can be confirmed by a visual inspection but the amount of the development is not greater than the tile surface on which the solution is not coated was evaluated as “anti-mold level 2”. Also, the one that the development of mycelia at a same level with the tile surface on which the solution is not coated can be confirmed was evaluated as “anti-mold level 1”. In the anti-mold level after the dissolution test, the one positioned on the level 3 or level 2 was judged as “OK”, while the one positioned on the level 1 was judged as “NG”.

The results of judgment on Evaluation 4 are shown in Table 6.

TABLE 6

Anti-mold level

| Solution | First stage | After dissolution test | Judgment |
|---|---|---|---|
| Example 5 | 2 | 2 | OK |
| Comparative | 3 | 1 | NG |
| Example 7 | | | |

As shown in Table 6, with respect to the specimen on which the solution of Example 5 is coated, there was no change in the anti-mold level of the coating film surface before and after the dissolution test, so that it is evaluated as the level 2 and judged as “OK”. Unlike this, with respect to the specimen on which the solution of Comparative example 7 is coated, the anti-mold level in the first stage was high because a large amount of copper is contained. However, the coating film did not remain after the dissolution test due to the accelerated dissolution thereof, and the mycelia developed at the same level with the blank, whereby it was judged as “NG”.

Evaluation 5: Antibacterial Effect

Specimens were obtained by flow coating the solutions of Example 2 and Example 7 in Table 1 and Comparative example 7, Comparative example 12 and Comparative example 14 in Table 2 on an upright slide glass and drying them at a temperature of 25 degrees centigrade for 12 hours. The antibacterial performance before and after carrying out the dissolution test referred to in the section of “(Film thickness)” was evaluated with colon bacilli (IS03972) based on JIS Z 2801. The one that the antibacterial active value R of the specimen coating film surface after the dissolution test calculated by the following formula is not less than 2 was judged as “OK” and the one that it is less than 2 was judged as “NG”.
Antibacterial active value R=Log10(Cs/Cb)
Cs: The number of colon bacillus on a solution coating surface after being cultured for 24 hours
Cb: The number of colon bacillus on an uncoated glass surface after being cultured for 24 hours

The results of judgment on Evaluation 5 are shown in Table 7.

TABLE 7

Antibacterial active value R

| Solution | First stage | After dissolution test | Judgment |
|---|---|---|---|
| Example 2 | 5.31 | 5.31 | OK |
| Example 7 | 5.31 | 4.49 | OK |
| Comparative | 5.31 | 0.48 | NG |
| Example 7 | | | |
| Comparative | 5.31 | 0.69 | NG |
| Example 12 | | | |
| Comparative | 5.31 | 0.35 | NG |
| Example 14 | | | |

As shown in Table 7, with respect to the specimen on which the solution of Example 2 is coated, there was no change in the antibacterial property of the coating film surface before and after carrying out the dissolution test and the active value R was 5.31. Also, with respect to the specimen of Example 7, the antibacterial property decreased a little but the active value R was 4.49. Therefore, both were judged as “OK”.

On the other hand, with respect to the specimens coated by the solutions of Comparative example 2, Comparative example 12 and Comparative example 14, the high antibacterial property was shown in the first stage because the large amount of copper, zinc or silver is contained in the coating film. However, the coating film did not remain after the dissolution test due to the accelerated dissolution thereof and the active value R was less than 1, whereby those were judged as “NG”.

Evaluation 6: Water Scale Adhesion Preventing Effect

There is used as a base material a tile having the 60° gloss value of 92 measured in accordance with JIS Z 8741. “Evian (Registered trademark)” of 297.5 in solidity was sprayed on an uncoated surface and coating film surfaces which are formed by flow coating the solutions of Example 2 and Example 7 in Table 1 and Comparative example 19 in Table 2 and drying at a temperature of 25 degrees centigrade for 60 minutes. A process of spraying five times and drying them for 60 minutes at a temperature of 25 degrees centigrade as one cycle was repeated ten cycles, and the 60° gloss value of the surface before spraying and after ten cycles was measured in accordance with JIS Z 8741. The one retaining not less than 85 of the gloss value was judged as “OK” while the one dropping to less than 85 of the gloss value was judged as “NG”.

The results of judgment on Evaluation 8 are shown in Table 8.

TABLE 8

| Solution | Change in external appearance and Gloss | Judgment |
|---|---|---|
| Example 2 | Clean and Substantially no change in gloss | OK |
| Example 7 | Clean and Substantially no change in gloss | OK |
| Comparative | Spotted dirt and Decrease in gloss | NG |
| example 19 | | |
| Uncoated | Spotted dirt and Decrease in gloss | NG |

As shown in Table 8, the surfaces coating the solutions of Example 2 and Example 7 each retained 85 or more of the 60° gloss value and were clean, thereby being judged as “OK”. On the other hand, to the uncoated tile surface and the surface coating the solution of Comparative example 19 the white spotted dirt adhered and the 60° gloss value were less than 85 thereby being judged as “NG”.

Evaluation 7: Antifouling Evaluation 4/Watermark Prevention in Dew Condensation Environment

Specimens prepared by coating and spreading over with a sponge the solutions of Example 7 in Table 1 and Comparative example 17 in Table 2 on a surface of an aluminum plate with an electrodeposited acryl coating film surface made by Paltec Co., Ltd. and drying them at a temperature of 25 degrees centigrade for 12 hours, and a specimen of an uncoated aluminum plate are used, and a dew condensation formation test was carried out. A water tank filled with water at a temperature of 5 degrees centigrade was installed in a room of a temperature at 20 degrees centigrade and 70% of relative humidity. A process of having the specimens adhered to an outer lateral wall of the water to let them stand for 120 minutes and drying them for 60 minutes as one cycle was repeated three cycles. As false dirt, a gauze by which the dirt adhered to the practically used window frame is wiped out was tacked on the lateral wall of the water tank above the specimens. Changes over time of the specimen surface were observed. The one that no dirt is found by visual inspection after the completion of three cycles was judged as “OK” while the one that the spotted dirt remainders are found by visual inspection was judged as “NG”.

The results of judgment on Evaluation 7 are shown in Table 9.

TABLE 9

| Solution | Dirt after completion of three cycles | Judgment |
|---|---|---|
| Example 7 | Substantially no dirt | OK |
| Comparative | Dissolved coating film was mixed | OK |
| example 17 | with dust and markedly dirty | |
| Uncoated | Dust adhered spottily | NG |

As shown in Table 9, with respect to the surface coated by the solution of Example 7, a water film was formed with occurrence of the dew condensation. Therefore, the marked dirt adhesion was not confirmed after the test and the surface was kept clean. On the other hand, with respect to the surface coated by Comparative example 17, the coating film was dissolved with occurrence of the dew condensation to start gradually splitting open on the surface of the acryl plate and, after the test is completed, mixed with dust flowing down from the upper side of the specimen thereby becoming markedly dirty. To the uncoated surface of the acryl plate, the dust adhered spottily.

1. A composite member comprising a base material having a hard surface, and a gradually soluble coating film being formed at normal temperature in a region with which water temporarily contacts, wherein said gradually soluble coating film contains at least a kind of water soluble polymer selected from the group of polyvinyl alcohol, polyacrylamide and hydroxyethyl cellulose, and metal salt forming a poorly-soluble hydroxide.

2. The composite member according to claim 1, wherein said metal salt comprises salt of metal ion in which the solubility product of said hydroxide is less than 1×10⁻¹⁶.

3. The composite member according to claim 1, wherein said metal salt forming the poorly-soluble hydroxide comprises at least a kind of water soluble salt of metal ion selected from the group of Al(III), Fe(III), Cu(II) and Cr(III).

4. The composite member according to of claim 1, wherein said coating film has not less than 20% and not more than 85% of a coating thickness retention after dipping in ion exchange water at a water temperature of 20 degrees centigrade for 10 minutes.

5. A coating composition contains at least a kind of water soluble polymer selected from the group of polyvinyl alcohol, polyacrylamide and hydroxyethyl cellulose, and metal salt forming a poorly-soluble metal hydroxide, in water.

6. The coating composition according to claim 5, wherein the solubility product of said metal hydroxide is less than 1×10⁻¹⁶.

7. The coating composition according to claim 5, wherein a metal ion forming said metal hydroxide comprises at least a kind selected from the group of Al(III), Fe(III), Cu(II) and Cr(III).

8. The coating composition according to claim 5, wherein a pH is not greater than 7 when being measured at a solution temperature of 20 degrees centigrade.

9. The coating composition according to claim 5, wherein a pH is greater than 4 and not greater than 7 when being measured at a solution temperature of 20 degrees centigrade.

10. The composite member according to claim 2, wherein said metal salt forming the poorly-soluble hydroxide comprises at least a kind of water soluble salt of metal ion selected from the group of Al(III), Fe(III), Cu(II) and Cr(III).

11. The composite member according to claim 2, wherein said coating film has not less than 20% and not more than 85% of a coating thickness retention after dipping in ion exchange water at a water temperature of 20 degrees centigrade for 10 minutes.

12. The coating composition according to claim 6, wherein a metal ion forming said metal hydroxide comprises at least a kind selected from the group of Al(III), Fe(III), Cu(II) and Cr(III).

13. The coating composition according to claim 6, wherein a pH is not greater than 7 when being measured at a solution temperature of 20 degrees centigrade.

14. The coating composition according to claim 6, wherein a pH is greater than 4 and not greater than 7 when being measured at a solution temperature of 20 degrees centigrade.
